(19) United States
(12) Patent Application Publication
(10) Pub. No.: US 2026/0237712 A1
(43) Pub. Date: Aug. 13, 2026

(54) FLEXIBLE DEVICE FOR MANUFACTURING BATTERY PACKS AND FLEXIBLE SYSTEM FOR MANUFACTURING BATTERY PACKS

(71) Applicant: CTNS Co., Ltd., Changwon-si, Gyeongsangnam-do (KR)

(72) Inventors: Kee-Jung KWON, Changwon-si, Gyeongsangnam-do (KR); In-Sung LEE, Changwon-si, Gyeongsangnam-do (KR); Ji Seung SEO, Changwon-si, Gyeongsangnam-do (KR); Jong-Yeol PARK, Gimhae-si, Gyeongsangnam-do (KR)

(21) Appl. No.: 19/160,004

(22) PCT Filed: Jan. 25, 2024
(86) PCT No.: PCT/KR2024/001245

§ 371 Date: Aug. 26, 2025

(30) Foreign Application Priority Data
Mar. 6, 2023 (KR) 10-2023-0029529
Mar. 6, 2023 (KR) 10-2023-0029530

(51) Int. Cl. H01M 10/04; B25J 11/00; G06F 16/2458

(52) U.S. Cl. CPC H01M 10/0404; B25J 11/005; G06F 16/2462

(57) ABSTRACT

A flexible device for manufacturing battery packs, according to an embodiment of the present inventive concept, comprises: a circulation transfer unit which transfers a transfer plate along a circular trajectory; a holder assembly unit disposed at a side of the trajectory of the circulation transfer unit to assemble holder assemblies and seat same on the transfer plate or battery cells; a cell supply unit which is disposed at a side of the trajectory of the circulation transfer unit and seats battery cells on the holder assemblies transferred through the transfer plate; and a conductive plate assembly unit which is disposed at a side of the circulation transfer unit and assembles a conductive plate on the holder assemblies seated on the upper part and the lower part of the battery cells.

### TECHNICAL FIELD

The present inventive concept relates to a device and system for manufacturing a battery pack, more specifically to a flexible device and system for manufacturing a battery pack that is capable of manufacturing the battery pack therethrough even under various requirements for the battery pack.

### BACKGROUND ART

A secondary battery can be recharged and reused multiple times and generally used for portable devices such as smartphones, laptops, electric tools, and the like and for electrical vehicles or hybrid electric vehicles (HEV) driven by an electrical driving force.

The secondary battery can significantly reduce fossil fuel consumption and also prevent by-products from being generated after the use of energy, so that the secondary battery is in the limelight as a new energy source that is ecofriendly and can improve energy efficiency.

Types of secondary batteries widely used at present include lithium-ion batteries, lithium-polymer batteries, nickel-cadmium batteries, nickel-metal hydride batteries, nickel-zinc batteries, etc. A unit secondary cell, namely a unit battery cell, typically operates within a range of 2.5 to 4.6 V. If it is required to have an output voltage higher than the voltage range, a plurality of battery cells may be connected in series to configure a battery pack.

In addition, depending on the charge/discharge capacity required for the battery pack, a plurality of battery cells may be connected in parallel to configure a battery pack, and otherwise, battery cells of the battery pack may be arranged in different way, depending on an installation space for the battery pack.

Therefore, a flexible manufacturing device for the battery pack has to be required according to various requirements such as different output voltages, different charge/discharge capacities, different sizes of battery packs, and the like.

However, a conventional device for manufacturing the battery pack can manufacture only standardized battery cells, and if the requirements for the battery pack are changed, therefore, the conventional device for manufacturing the battery pack has to be changed to meet the requirements for the battery pack. As a result, the conventional device cannot manufacture the battery pack, while meeting various requirements for the battery pack.

### DISCLOSURE

### Technical Problem

A flexible manufacturing device and system for a battery pack according to an embodiment of the present inventive concept has the following solutions to solve the above-mentioned problems occurring in the related art.

It is an object of the present inventive concept to provide a flexible manufacturing device for a battery pack that is capable of changing arrangements of battery cells according to various requirements for the battery pack.

It is another object of the present inventive concept to provide a flexible manufacturing device for a battery pack that is capable of making use of manufacturing data to provide an optimized battery pack process recipe according to requirements for the battery pack.

The technical problems to be achieved through the present inventive concept are not limited as mentioned above, and other technical problems not mentioned herein will be obviously understood by one of ordinary skill in the art through the following description.

### Technical Solution

To accomplish the above-mentioned objects, according to an embodiment of the present inventive concept, there is provided a flexible manufacturing device for a battery pack, including: a unidirectional transfer part for transferring a transfer plate from one side to the other side thereof; a first holder assembling part disposed on a side surface of the unidirectional transfer part to create a holder assembly and then seat the holder assembly on the transfer plate; a cell supply part disposed on the side surface of the unidirectional transfer part to seat battery cells on the holder assembly transferred through the transfer plate; a second holder assembling part disposed on the side surface of the unidirectional transfer part to create a holder assembly and then fit the holder assembly to the upper portions of the battery cells; and conductive plate assembling parts disposed on the side surface of the unidirectional transfer part to couple conductive plates to the holder assemblies fitted to the upper and lower portions of the battery cells.

The flexible manufacturing device for a battery pack according to the embodiment of the present inventive concept may further include pressing parts located on the unidirectional transfer part to press the battery cells seated onto the holder assemblies so that the coupled states of the battery cells to the holder assemblies become reinforced.

The first holder assembling part of the flexible manufacturing device for a battery pack according to the embodiment of the present inventive concept may include a holder reverser for turning the holder assembly upside down to seat the reversed holder assembly onto the transfer plate.

The conductive plate assembling parts of the flexible manufacturing device for a battery pack according to the embodiment of the present inventive concept may include a top conductive plate assembling part located on the side surface of the unidirectional transfer part to couple the conductive plate to the holder assembly fitted to the upper portions of the battery cells and an underside conductive plate assembling part located on the side surface of the unidirectional transfer part to couple the conductive plates to the holder assembly fitted to the lower portions of the battery cells, and between the top conductive plate assembling part and the underside conductive plate assembling part is located a semi-finished product reversing part to allow the battery cells to which the conductive plates are coupled by means of the top conductive plate assembling part to be reversed.

The first holder assembling part of the flexible manufacturing device for a battery pack according to the embodiment of the present inventive concept may include a holder arranging plate and a holder member feeder and a pin member feeder spaced apart from each other around the holder arranging plate, and holder members fed from the holder member feeder and fixing pins fed from the pin member feeder may move to the holder arranging plate through robot arms.

The holder arranging plate of the flexible manufacturing device for a battery pack according to the embodiment of the present inventive concept may include a base plate and a plurality of protrusions protruding from top of the base plate, and each holder member may consist of one cell insertion lead open on top and bottom thereof, grating walls bent from top corners of one cell insertion lead, and incised portions formed on one cell insertion lead under the grating walls, one side grating walls of the grating walls of one cell insertion lead being formed unitarily with the grating walls of the other cell insertion lead.

The robot arms of the flexible manufacturing device for a battery pack according to the embodiment of the present inventive concept may include the robot arm that moves one holder member of the holder members fed from the holder member feeder to allow one protrusion of the holder arranging plate into the cell insertion lead of one holder member and moves the other holder member of the holder members fed from the holder member feeder to the side surface of one holder member to allow one protrusion of the holder arranging plate into the cell insertion lead of the holder member and the robot arm that moves the fixing pin fed from the pin member feeder to allow the fixing pin to be inserted between one holder member and the other holder member, so that the holder assembly is created.

The holder reverser of the flexible manufacturing device for a battery pack according to the embodiment of the present inventive concept may include a holder frame with frame rotating shafts located at a central portion thereof, screw frames spaced apart from each other on a top surface of the holder frame, ball screws located on the screw frames, one side moving frame moving linearly along the screw frames upon the rotations of the ball screws, and the other side moving frame corresponding to one side moving frame and having a lead contact member protruding from the inner side thereof toward one side moving frame.

The cell supply part of the flexible manufacturing device for a battery pack according to the embodiment of the present inventive concept may include a cell moving slope along which the battery cells slide in one side direction, a cell aligner located on the other end of the cell moving slope to align the battery cells slidingly fed to the cell moving slope, a first cell grasping head for grasping the battery cells aligned on the cell aligner to move the battery cells to a cell seating plate located on the side surface of the unidirectional transfer part, and a second cell grasping head for grasping the battery cells that have moved to the cell seating plate to arrange the battery cells on the holder assemblies created by the first holder assembling part and then seated on the transfer plate.

The first cell grasping head of the flexible manufacturing device for a battery pack according to the embodiment of the present inventive concept may include a first grasping block, a pressure block located on top of the first grasping block, a first cell aligning block located on the underside of the first grasping block and having a plurality of grooves formed on the underside thereof in such a way as to correspond to the side peripheries of the battery cells and a plurality of magnetic field-producing coils located therein in such a way as to produce magnetic fields to allow attractive forces to be applied to the battery cells, pressure supply pipes passing through the pressure block, the first grasping block, and the first cell aligning block in such a way as to allow tops thereof to communicate with top of the pressure block and allow undersides thereof to communicate with the inner peripheries of the grooves of the first cell aligning block.

Between the cell aligner and the cell seating plate of the flexible manufacturing device for a battery pack according to the embodiment of the present inventive concept may be located a first head moving rail for moving the first cell grasping head, and the first grasping block may move up and down and be rotatable on the first head moving rail in such a way as to be transferred along the first head moving rail.

The second cell grasping head of the flexible manufacturing device for a battery pack according to the embodiment of the present inventive concept may include a second grasping block, a second cell aligning block located on the underside of the second grasping block and having grooves formed on the underside thereof in such a way as to insert tops of the battery cells thereinto, cylinder rods located on top of the second grasping block, fluid cylinders located inside the second cell aligning block in such a way as to move upward and downward, magnetic field-producing coils located inside the second cell aligning block to produce magnetic fields so that attractive forces are applied to the battery cells, and a second head moving rail located on the side surface of the cell seating plate to move the second cell grasping head toward the unidirectional transfer part.

To accomplish the above-mentioned objects, according to another embodiment of the present inventive concept, there is provided a flexible manufacturing device for a battery pack, including a circulation transfer part for transferring a transfer plate along a circular trajectory, a holder assembling part disposed at a side of the trajectory of the circulation transfer part to create holder assemblies and seat the holder assemblies on the transfer plate or battery cells, a cell supply part disposed at a side of the trajectory of the circulation transfer part to seat the battery cells on the holder assemblies transferred through the transfer plate, and a conductive plate assembling part disposed at a side of the circulation transfer part to couple conductive plates to the holder assemblies seated on the upper and lower portions of the battery cells.

The holder assembling part of the flexible manufacturing device for a battery pack according to another embodiment of the present inventive concept may include a holder arranging plate and a holder member feeder and a pin member feeder spaced apart from each other around the holder arranging plate, and holder members fed from the holder member feeder and fixing pins fed from the pin member feeder may move to the holder arranging plate through robot arms.

The holder arranging plate of the flexible manufacturing device for a battery pack according to another embodiment of the present inventive concept may include a base plate and a plurality of protrusions protruding from top of the base plate, and each holder member may consist of one cell insertion lead open on top and bottom thereof, grating walls bent from top corners of one cell insertion lead, and incised portions formed on one cell insertion lead under the grating walls, one side grating walls of the grating walls of one cell insertion lead being formed unitarily with the grating walls of the other cell insertion lead.

The robot arms of the flexible manufacturing device for a battery pack according to another embodiment of the present inventive concept may include the robot arm that moves one holder member of the holder members fed from the holder member feeder to allow one protrusion of the holder arranging plate into the cell insertion lead of one holder member and moves the other holder member of the holder members fed from the holder member feeder to the side surface of one holder member to allow one protrusion of the holder arranging plate into the cell insertion lead of the holder member and the robot arm that moves the fixing pin fed from the pin member feeder to allow the fixing pin to be inserted between one holder member and the other holder member, thereby creating the holder assembly.

The cell supply part of the flexible manufacturing device for a battery pack according to another embodiment of the present inventive concept may include a cell moving slope along which the battery cells slide in one side direction, a cell aligner located on the other end of the cell moving slope to align the battery cells slidingly fed to the cell moving slope, a first cell grasping head for grasping the battery cells aligned on the cell aligner to move the battery cells to a cell seating plate located on the side surface of the unidirectional transfer part, and a second cell grasping head for grasping the battery cells that have moved to the cell seating plate to arrange the battery cells on the holder assemblies created by the first holder assembling part and then seated on the transfer plate.

To accomplish the above-mentioned objects, according to yet another embodiment of the present inventive concept, there is provided a flexible manufacturing system for a battery pack, which serves to arrange battery cells and create holder assemblies fitted to upper and lower portions of the battery cells according to requirements for the battery pack, the flexible manufacturing system including: a battery order system for receiving the requirements for the battery pack from a customer; a process recipe system for analyzing the requirements received from the battery order system to produce a manufacturing process recipe for the battery pack; and a flexible manufacturing device for the battery pack which performs the manufacturing process recipe for the battery pack produced from the process recipe system, wherein the received requirements of the battery order system comprise the quantity, size, output volage, and capacity of the battery pack, and the manufacturing process recipe for the battery pack comprises the arrangements of the holder assemblies.

The flexible manufacturing device of the flexible manufacturing system for a battery pack according to yet another embodiment of the present inventive concept may include holder assembling parts for creating the holder assemblies according to the arrangements of the holder assemblies produced through the process recipe system, a cell supply part for seating the battery cells on the holder assemblies created through the holder assembling parts according to the arrangements of the holder assemblies produced through the process recipe system, and conductive plate assembling parts for cutting and coupling conductive plates according to the arrangements of the holder assemblies produced through the process recipe system.

The flexible manufacturing device of the flexible manufacturing system for a battery pack according to yet another embodiment of the present inventive concept may include sensors located on the holder assemblies, the cell supply part, and the conductive plate assembling parts to sense operation record data so that the data sensed through the sensors are transmitted to a learning system included in the process recipe system, and the learning system may include a data transmission and reception unit for requesting and receiving the operation record data collected by the flexible manufacturing device, a database for storing the operation record data received from the data transmission and reception unit, a pre-processor for rectifying the operation record data stored in the database and calculating statistical data based on the rectified data, and a learning unit for extracting process conditions having influences on the amount of change in a process result, based on the statistical data calculated through the pre-processor, to produce a manufacturing process recipe model for the battery pack.

The learning unit of the flexible manufacturing system for a battery pack according to yet another embodiment of the present inventive concept may include an operating unit for analyzing the correlation between process factors and the amount of change in the process result through the statistical data to extract a high influence process condition on the amount of change in the process result and a model producing unit for making use of the extracted process condition to produce the manufacturing process recipe model for the battery pack.

The operating unit of the flexible manufacturing system for a battery pack according to yet another embodiment of the present inventive concept may determine, if the amount of change in the process result that is made when a process condition is changed is over a reference value, the process condition as the high influence process condition.

The manufacturing process recipe model for the battery pack of the flexible manufacturing system for a battery pack according to yet another embodiment of the present inventive concept may be updated in the process recipe system.

### Advantageous Effects of Inventive Concept

The flexible manufacturing device and system for a battery pack according to the present inventive concept can change the arrangements of the holder assemblies to be coupled to the battery cells according to various requirements for the battery pack and then couple the battery cells to the holder assemblies changed in arrangement, thereby enabling various types of battery packs according to such various requirements.

Further, the flexible manufacturing device for a battery pack according to the present inventive concept can make use of the process data acquired in the battery pack manufacturing process to optimize the manufacturing process, thereby providing high productivity.

The effectiveness of the inventive concept is not limited as mentioned above, and it should be understood to those skilled in the art that the effectiveness of the inventive concept may include another effectiveness as not mentioned above from the detailed description of the present inventive concept.

### BRIEF DESCRIPTION OF DRAWINGS

FIG. 1 is a side view showing a flexible manufacturing device for a battery pack according to an embodiment of the present inventive concept.

FIG. 2 is a plan view showing a first holder assembling part of FIG. 1.

FIG. 3 is a perspective view showing a holder arranging plate of FIG. 1.

FIG. 4 is a perspective view showing a process in which a holder assembly is coupled to the holder arranging plate of FIG. 3.

FIG. 5 is a perspective view showing a holder reverser of FIGS. 1 and 2.

FIG. 6 is a plan view showing a cell supply part of FIG. 1.

FIG. 7 is a perspective view showing operations of a cell aligner of FIG. 6.

FIG. 8 is a sectional view showing a first cell grasping head of FIG. 6.

FIG. 9 is a sectional view showing a second cell grasping head of FIG. 6.

FIG. 10 is a side view showing a first pressing part of FIG. 1.

FIG. 11 is a perspective view showing operations of a semi-finished product reversing part of FIG. 1.

FIG. 12 is a schematic view showing a flexible manufacturing device for a battery pack according to another embodiment of the present inventive concept.

FIG. 13 is a block diagram showing a flexible manufacturing system for a battery pack according to yet another embodiment of the present inventive concept.

FIG. 14 is a block diagram showing a flexible manufacturing device and a learning system of FIG. 13.

FIG. 15 is a graph showing result values according to changes in process conditions.

### BEST MODE FOR INVENTIVE CONCEPT

Hereinafter, embodiments of the present inventive concept will be described in detail with reference to the accompanying drawings wherein the corresponding parts in the embodiments of the present inventive concept are indicated by corresponding reference numerals and the repeated explanation on the corresponding parts will be avoided.

Further, if it is determined that the detailed explanation on the well-known technology related to the present inventive concept makes the scope of the present inventive concept not clear, the explanation will be avoided for the brevity of the description. Furthermore, the disclosed embodiments may not be limited to the shapes as shown in the drawings unless otherwise defined and they may have some variations.

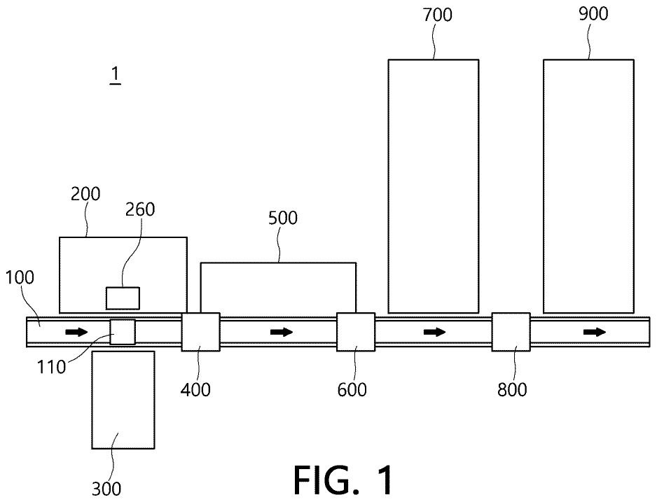

Referring to FIG. 1 showing a flexible manufacturing device for a battery pack according to an embodiment of the present inventive concept, the flexible manufacturing device 1 for a battery pack includes a unidirectional transfer part 100, a first holder assembling part 200, a cell supply part 300, a second holder assembling part 500, and conductive plate assembling parts 700 and 900.

The unidirectional transfer part 100 serves to transfer holder assembly 10 created by the first holder assembling part 200, the cell supply part 300, and the second holder assembling part 500 and battery cells B in a direction from the left to the right of FIG. 1, and according to the embodiment of the present inventive concept, a chain driven conveyor is used as the unidirectional transfer part 100, but without being limited thereto, a transfer device using various driving members such as a belt, and the like may be used as the unidirectional transfer part 100. Further, the unidirectional transfer part 100 may not be limited to a device moving linearly, and therefore, a device that is not circulated may be included in the unidirectional transfer part 100. The unidirectional transfer part 100 includes a transfer plate 110 moving therealong in one direction in such a way as to seat the holder assembly 10 thereon.

The unidirectional transfer part 100 is typically used, and therefore, a specific explanation of the unidirectional transfer part 100 will be avoided.

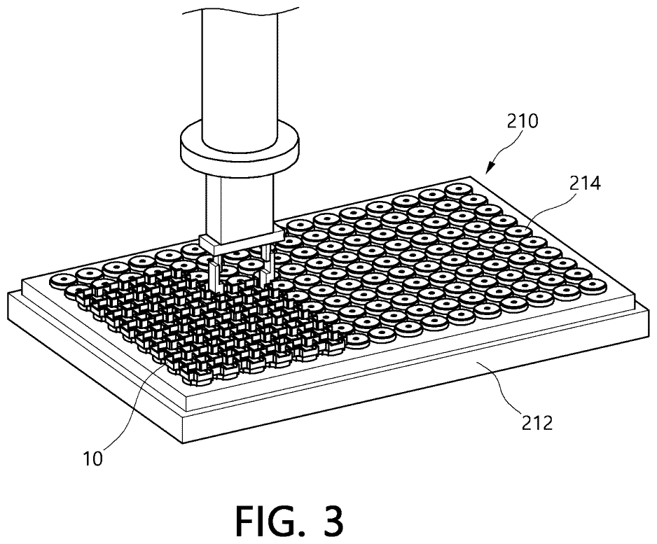

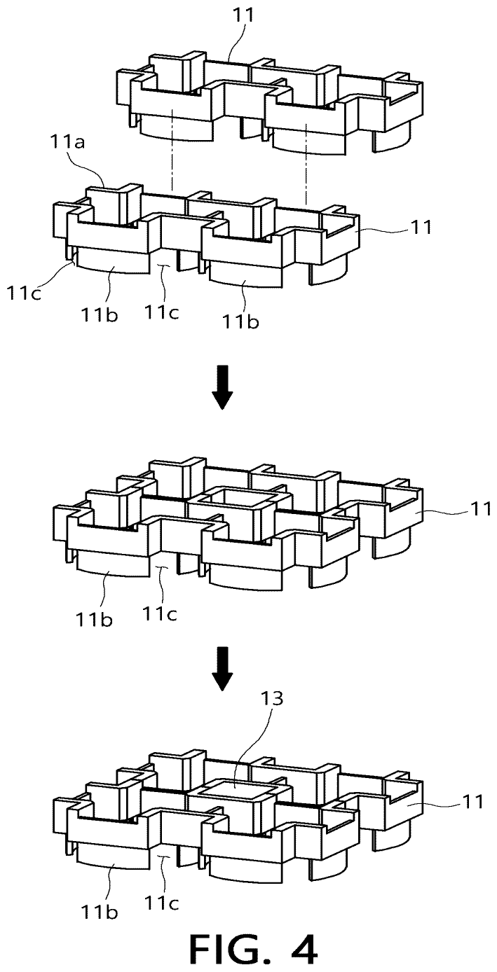

As shown in FIG. 3 showing a perspective view of a holder arranging plate and as shown in FIG. 4 showing a process in which the holder assembly is coupled to the holder arranging plate, the first holder assembling part 200 serves to create the holder assembly 10, and the first holder assembling part 200 has the same configuration as the second holder assembling part 500. The first holder assembling part 200 and the second holder assembling part 500 will be described in detail later with reference to FIGS. 3 and 4.

The cell supply part 300 serves to seat the battery cells B on the holder assembly 10 created by the first holder assembling part 200 in such a way as to move the battery cells B correspondingly to the holder assembly 10.

The conductive plate assembling parts 700 and 900 serve to connect the battery cells B to one another through conductive plates in such a way as to connect the electrodes of the battery cells B fitted to the holder assembly 10 created by the first holder assembling part 200 and the second holder assembling part 500 in upward and downward directions.

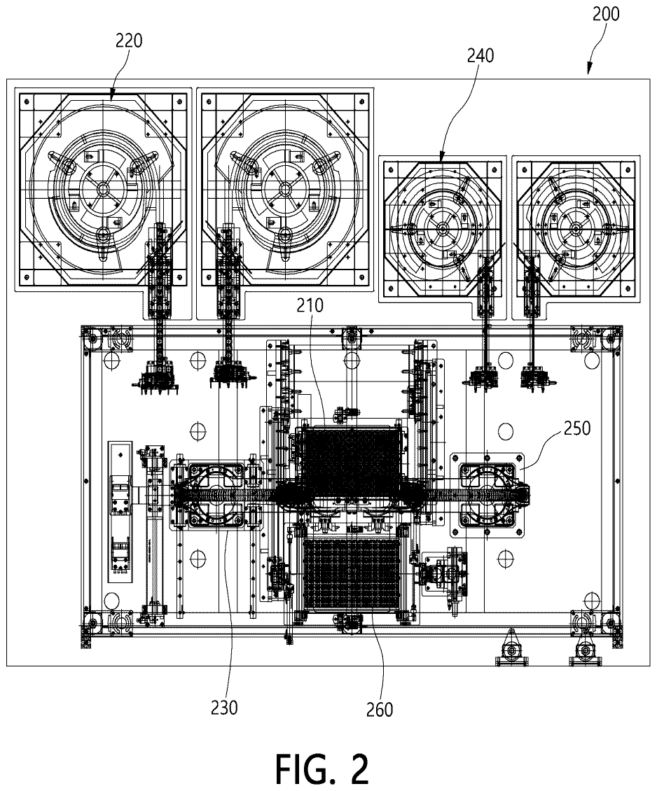

Referring to FIG. 2 that is a plan view showing the first holder assembling part of FIG. 1, the first holder assembling part 200 includes a holder member feeder 220 for feeding holder members 11 and a pin member feeder 240 for feeding fixing pins 13 for fixing the holder members 11 located on the holder arranging plate 210, around the holder arranging plate 210 for arranging the holder members 11 for constructing the holder assembly 10, and further, robot arms 230 and 250 are located between the holder feeder 220 and the pin member feeder 240.

The robot arms 230 and 250 grasp the holder members 11 in the holder member feeder 220 and transfer them to the holder arranging plate 210, as shown in FIG. 3, and after the holder members 11 have been arranged, as shown in FIG. 3, the robot arms 230 and 250 grasp the fixing pins 13 in the pin member feeder 240, transfer them, and insert each fixing pin 13 between the holder members 11 arranged on the holder arranging plate 210, thereby creating the holder assembly 10.

The holder member feeder 220 and the pin member feeder 240 serve to align and feed the holder members 11 and the fixing pins 13, and according to the embodiment of the present inventive concept, bowl feeders are used as the holder member feeder 220 and the pin member feeder 240. Of course, various devices may be used as the holder member feeder 220 and the pin member feeder 240.

The robot arm 230, which is used in the embodiment of the present inventive concept, is a holder member transfer arm for moving and arranging the holder members 11 in the holder member feeder 220, and the robot arm 250, which is used in the embodiment of the present inventive concept, is a pin member transfer arm 250 for grasping and transferring the fixing pins 13 in the pin member feeder 240 to couple each fixing pin 13 to the holder members 11. If a robot arm is widen in a movable range and quickly movable, however, the single robot arm may be used as the robot arms 230 and 250. According to the embodiment of the present inventive concept, moreover, the robot arms 230 and 250 are SCARA robot arms as horizontally articulated robot arms, but various types of robot arms may be used only if they grasp, transfer, and arrange the holder members 11 and the fixing pins 13.

Referring to FIG. 3 as the perspective view showing the holder arranging plate and FIG. 4 as the perspective view showing the process in which the holder assembly is coupled to the holder arranging plate of FIG. 3, explanations of the holder arranging plate 210 and the holder members 11 will be given in detail below.

As shown in FIG. 3, the holder arranging plate 210 consists of a base plate 212 and protrusions 214 protruding from top of the base plate 212.

The protrusions 214 have the shapes corresponding to tops or undersides of the battery cells B, and the battery cells B, which are used according to the embodiment of the present inventive concept, are cylindrical cells, so that the protrusions protruding from top of the base plate 212 are cylindrical. If square battery cells B are used, square protrusions protrude from the base plate 212.

As shown in FIG. 4, each holder member 11 arranged on the holder arranging plate 210 as shown in FIG. 3 consists of one cell insertion lead 11b open on top and bottom thereof, grating walls 11a bent from upper corners of one cell insertion lead 11b, and incised portions 11c formed on one cell insertion lead 11b under the grating walls 11a, and one side grating walls of the grating walls 11a of one cell insertion lead 11b are formed unitarily with the grating walls 11a of the other cell insertion lead 11b.

The holder member 11 includes the cell insertion lead 11b into which top or underside of each battery cell B is inserted and the grating walls 11a bent to the shape of ‘┐’ to support the cell insertion lead 11b, and the grating walls 11a adjacent to one another are formed unitarily. According to the embodiment of the present inventive concept, as shown in FIG. 4, the holder member 11 with the two cell insertion leads 11b is used, but according to embodiments of the present inventive concept, the holder member 11 with three or more cell insertion leads 11b may be used.

The incised portions 11c are formed on each cell insertion lead 11b to allow the corresponding battery cell B to be easily inserted into the cell insertion lead 11b, and in this case, the incised portions 11c may be formed on various position of the cell insertion lead 11b. If the incised portions 11c are formed under the grating walls 11a supporting the cell insertion lead 11b, however, the holder member 11 becomes firmer. Therefore, it is desirable that the incised portions 11c should be formed under the grating walls 11a.

As mentioned above, the holder member 11 is used in both of the first holder assembling part 200 and the second holder assembling part 500.

As shown in FIG. 3, a process of putting together the holder members 11 to create the holder assembly 10 is performed by arranging the holder members 11 fed from the holder member feeder 220 on the holder arranging plate 210 according to a predetermined arrangement plan and then fixing each fixing pin 13 between the holder members 11. The holder arranging plate 210 has the protrusions 214 protruding therefrom to allow the holder assembly 10 to be provided according to various battery cells B.

The robot arm 230 moves the holder members 11 fed from the holder member feeder 220 and arranges the holder members 11 on the holder arranging plate 210 in such a way as to allow the protrusions 214 of the holder arranging plate 210 to be inserted into the insides of the cell insertion leads 11b of the holder members 11, and the robot arm 250 moves the fixing pins 13 fed from the pin member feeder 240 and couples each fixing pin 13 between the holder members 11. As a result, the holder assembly 10 is created.

The battery cells B are inserted into the holder assembly 10 in a direction toward the holder arranging plate 10, and to allow the battery cells B to be inserted into the holder assembly 10, the holder assembly 10 should turn upside down. In the case where the holder assembly 10 is fitted to the battery cells B in a state where the battery cells B are arranged, there is no need to turn the holder assembly 10 upside down. Therefore, the second holder assembling part 500, which serves to fit the holder assembly 10 to the battery cells B in the state where the battery cells B are arranged, has no holder reverser 260, unlike the first holder assembling part 200.

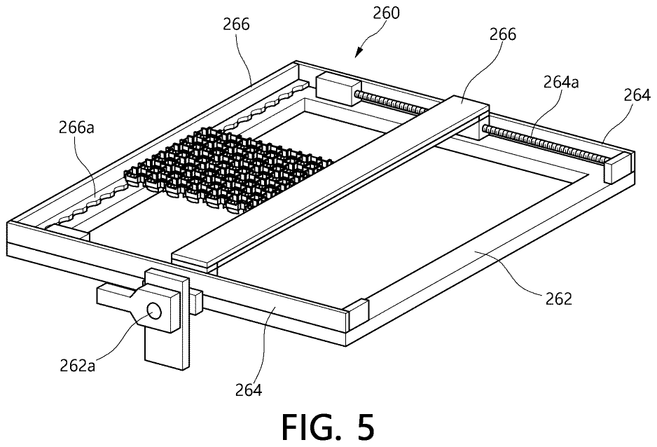

Various devices such as a robot arm, and the like may be used as the holder reverser 260 for reversing the holder assembly 10, but since the holder assembly 10 has to be quickly reversed, such a holder reverser 260 capable of fixing the holder assembly 10 thereto and turning it is desirably used, as shown in FIG. 5,.

The holder reverser 260 includes a holder frame 262 as a main frame, a pair of moving frames 266 spaced apart from each other in such a way as to move on the holder frame 262, and screw frames 264 for coupling the moving frames 266 to the holder frame 262 to move the moving frames 266.

The holder frame 262 is a frame that rotates together with frame rotating shafts 262a if the frame rotating shafts 262a rotate, while having various shapes, but to allow a load occurring upon the rotation to decrease, desirably, the holder frame 262 is open on the central portion thereof.

Motors for rotating the frame rotating shafts 262a are not shown in the drawings, but various mechanical elements such as belts, gears, and the like may be used.

The screw frames 264 which are located parallel to each other are fitted to the frame rotating shafts 262a, and ball screws 264a are located at the insides of the screw frames 264 and rotate by means of motors.

One side moving frame 266 is located on the ball screws 264a and has nuts moving along the screw threads of the ball screws 264a, and the other side moving frame 266 is located on one end of the screw frames 264 in such a way as to correspond to the moving frame 266. The other side moving frame 266 has a lead contact member 266a protruding from the inner side thereof toward one side moving frame 266, and the lead contact member 266a has the shape corresponding to the shapes of the cell insertion leads 11b.

The holder assembly 10 of the first holder assembling part 200 moves between the moving frames 266 of the holder reverser 260 through the robot arms 230 and 250, and if the holder assembly 10 moves between the moving frames 266, one side moving frame 266 moves to fix the holder assembly 10 thereto. In this case, the frame rotating shafts 262 rotate by 180° to allow the holder assembly 10 to be reversed. After that, the robot arms 230 and 250 move the holder assembly 10 to the transfer plate 110 of the unidirectional transfer part 100.

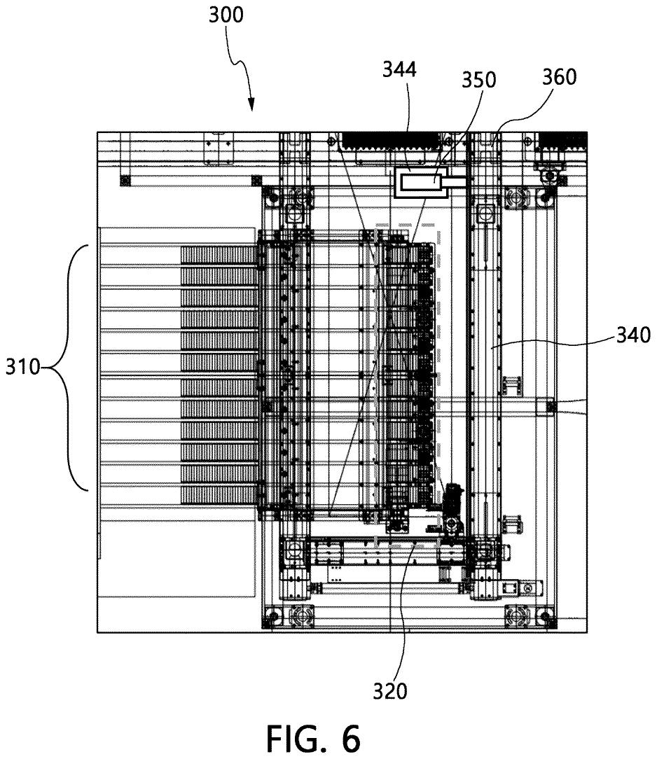

The cell supply part 300 serves to arrange the battery cells B on the holder assembly 10 moving from the first holder assembling part 200, and as shown in FIG. 6 that is a plan view showing the cell supply part of FIG. 1, the cell supply part 300 includes a cell moving slope 310 along which the battery cells B slide in one side direction, a cell aligner 320 located on the other end of the cell moving slope 310 to align the battery cells B slidingly fed to the cell moving slope 310, a first cell grasping head 330 for grasping the battery cells B aligned on the cell aligner 320 to move the battery cells B to a cell seating plate 344 located on the side surface of the unidirectional transfer part 100, and a second cell grasping head 350 for grasping the battery cells B that have moved to the cell seating plate 344 to arrange the battery cells B onto the holder assembly 10 created by the first holder assembling part 200 and then seated on the transfer plate 110.

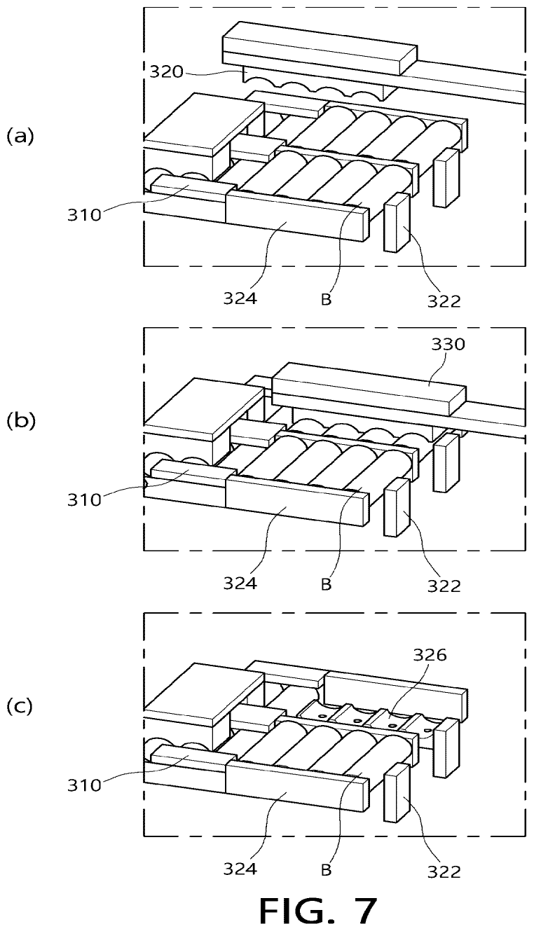

As shown in FIG. 1, the cell moving slope 310 has the shape of a slope allowing the battery cells B to slide by means of their self weight, and as shown in FIG. 7 that is a perspective view showing operations of the cell aligner of FIG. 6, the cell aligner 320 is located on the end portion of the cell moving slope 310.

The cell aligner 320 includes side walls 324 located on the side surfaces thereof and a deviation prevention wall 322 located on the other end of each side wall 324. Further, a cell seating block 326 is located in a space defined by the side walls 324 and the corresponding deviation prevention wall 322 in such a way as to move upward and downward. If the cell seating block 326 moves upward, it is higher in height than the other side battery cells B among the battery cells B moving along the cell moving slope 310, so that in the case where the cell seating block 326 moves upward, it prevents the battery cells B from moving along the cell moving slope 310. To the contrary, if the cell seating block 326 moves downward, it is lower in height than the other side battery cells B among the battery cells B moving along the cell moving slope 310, so that the battery cells B move naturally to top of the cell seating block 326.

The cell seating block 326 has a plurality of concave grooves formed on top thereof in such a way as to seat the side peripheries of the battery cells B thereonto.

As shown in FIG. 7, the side peripheries of the battery cells B seated onto the cell seating block 326 are arranged in downward directions, and to allow the battery cells B to be inserted into the cell insertion leads 11b of the holder assembly 10, therefore, the battery cells B have to rotate by 90°.

The first cell grasping head 330 for grasping the battery cells B seated onto the cell seating block 326 grasp the battery cells B, rotate the battery cells B by 90°, and move the battery cells B after the rotation. To insert the battery cells B into the cell insertion leads 11b of the holder assembly 10, a force has to be applied to the battery cells B in a direction from tops of the battery cells B toward undersides thereof. Therefore, the first cell grasping head 330 grasps the side peripheries of the battery cells B, rotates them by 90°, and seats them onto the cell seating plate 344, and the second cell grasping head 350 grasps tops of the battery cells B, moves the battery cells B to the holder assembly 10 seated onto the transfer plate 110, and presses them against the holder assembly 10.

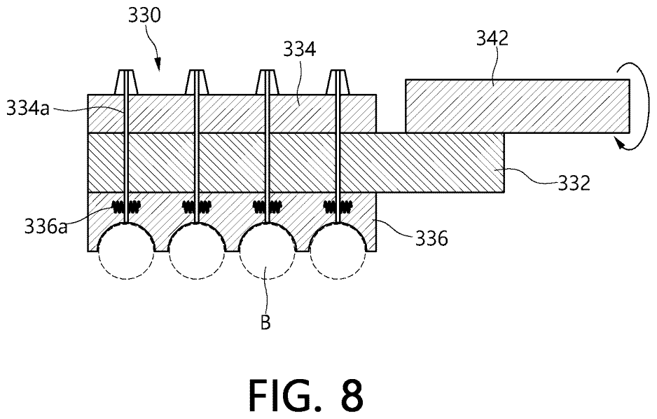

As shown in FIG. 8 that is a sectional view showing the first cell grasping head of FIG. 6, the first cell grasping head 330, which grasps the side peripheries of the battery cells B, rotates them by 90°, and moves them to the cell seating plate 344, includes a first grasping block 332, a pressure block 334 located on top of the first grasping block 332, and a first cell aligning block 336 located on the underside of the first grasping block 332.

The first cell aligning block 336 has a plurality of grooves formed on the underside thereof in such a way as to correspond to the side peripheries of the battery cells B and a plurality of magnetic field-producing coils 336a located therein in such a way as to produce magnetic fields to allow attractive forces to be applied to the battery cells B. As shown in FIG. 7b, if the first cell aligning block 336 is brought into close contact with the battery cells B on the cell seating block 326 of the cell aligner 320, power is applied to the magnetic field-producing coils 336a to allow the battery cells B to be attractive to the first cell aligning block 336, and in this case, the first grasping block 332 rotates by 90° and moves to the cell seating plate 344.

In this case, pressure supply pipes 334a pass through the pressure block 334, the first grasping block 332, and the first cell aligning block 336 in such a way as to allow tops thereof to communicate with top of the pressure block 334 and allow undersides thereof to communicate with the inner peripheries of the grooves of the first cell aligning block 336 and thus supply negative pressures to the grooves of the first cell aligning block 336. If the first cell aligning block 336 is brought into close contact with the battery cells B on the cell seating block 326 of the cell aligner 320, the negative pressures are supplied to the pressure supply pipes 334a to allow the battery cells B to be attractive to the first cell aligning block 336.

If the first cell grasping head 330 grasps the battery cells B, rotates them, and seats them onto the cell seating plate 344, the magnetic field-producing coils 336a stop producing the magnetic fields, and the pressure supply pipes 334a stop supplying the negative pressures. According to embodiments of the present inventive concept, further, the negative pressures produced through the pressure supply pipes 334a may turn into fine positive pressures.

Between the cell aligner 320 and the cell seating plate 344 is located a first head moving rail 340 for moving the first cell grasping head 330, and the first grasping block 332 of the first cell grasping head 330 has a first rail connection rod 342 connected to the first head moving rail 340.

According to embodiments of the present inventive concept, the first cell grasping head 330 moves upward and downward as well as moves horizontally along the first head moving rail 340 after the rotation.

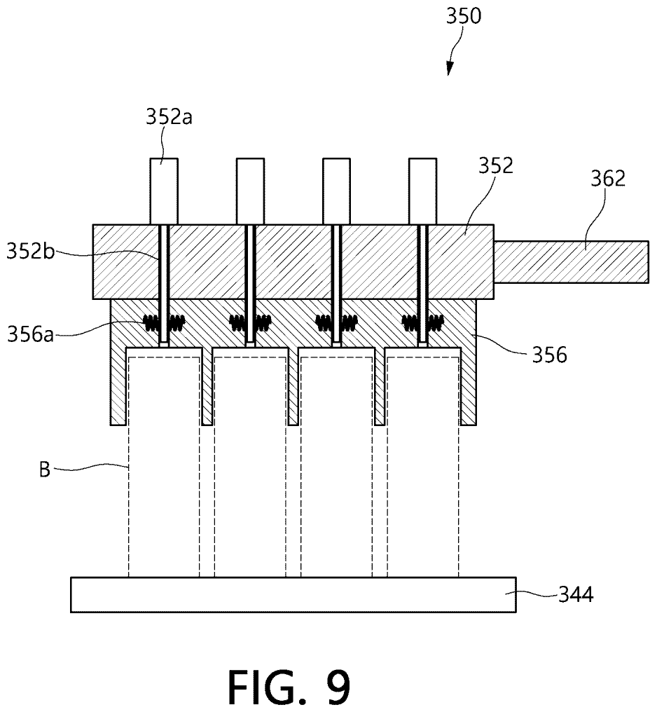

As shown in FIG. 9 that is a sectional view showing a second cell grasping head of FIG. 6, in a state where the upper portions of the battery cells B seated onto the cell seating plate 344 are grasped by the second cell grasping head 350, the battery cells B move to the holder assembly 10 seated on the transfer plate 110.

To allow the second cell grasping head 350 to move, a second head moving rail 360 is located on the side surface of the cell seating plate 344 so that it moves the second cell grasping head 350 toward the unidirectional transfer part.

As shown in FIG. 9, the second cell grasping head 350 includes a second grasping block 352 and a second cell aligning block 356 located on the underside of the second grasping block 352 and having grooves formed on the underside thereof in such a way as to insert upper portions of the battery cells B thereinto. Further, cylinder rods 352a are located on top of the second grasping block 352, and fluid cylinders 352b are located inside the second cell aligning block 356 in such a way as to move upward and downward.

In this case, magnetic field-producing coils 356a are located inside the second cell aligning block 356, like the above-mentioned first cell aligning block 336, to produce magnetic fields so that attractive forces are applied to the battery cells B.

The second cell grasping head 350 moves to allow the upper portions of the battery cells B seated onto the cell seating plate 344 to be inserted into the grooves of the second cell aligning block 356, and next, power is applied to the magnetic field-producing coils 356a to allow the second cell grasping head 350 to grasp the battery cells B, so that the battery cells B move to the holder assembly 10 seated onto the transfer plate 110. After that, the operations of the magnetic field-producing coils 356a stop, and the fluid cylinders 352b are driven to move the cylinder rods 352a so that the battery cells B move downward by means of the cylinder rods 352a and are inserted into the cell insertion leads 11b of the holder assembly 10.

In the case where the battery cells B are inserted into the cell insertion leads 11b of the holder assembly 10, they may not be inserted thereinto by predetermined depths, and as shown in FIG. 1, therefore, pressing parts 400 and 600 are located between the first holder assembling part 200 and the second holder assembling part 500 and between the second holder assembling part 500 and the conductive plate assembling parts 700 and 900 on the unidirectional transfer part 100 to press the battery cells B seated onto the holder assembly 10 so that the coupled states of the battery cells B to the holder assembly 10 become reinforced.

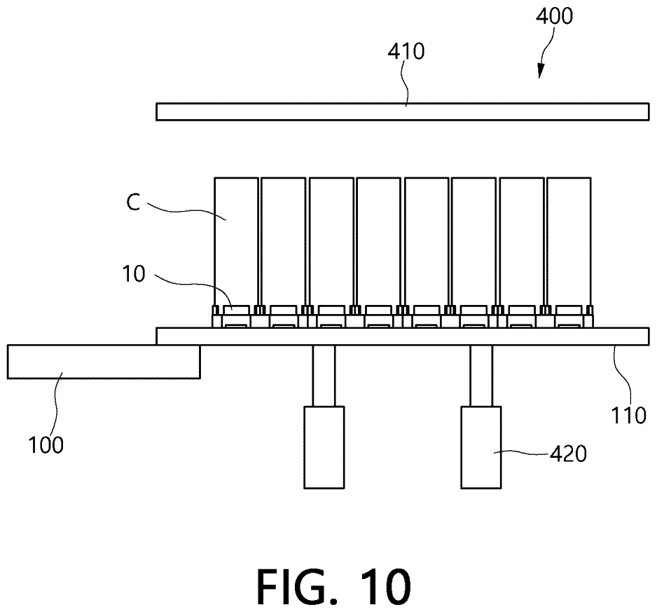

As shown in FIG. 1, the pressing parts 400 and 600 are called a first pressing part 400 and a second pressing part 600 according to their position, but since they are defined according to their position, for the conveniences of the description, they have the same configuration as each other. Therefore, the first pressing part 400 will be explained with reference to FIG. 10 showing the first pressing part 400, for the brevity of the description.

The first pressing part 400 includes pressing cylinders 420 located at a lower position than the transfer plate 110 to allow the transfer plate 110 moving along the unidirectional transfer part 100 to move upward and a top support plate 410 located above the pressing cylinders 420 at a higher position than the transfer plate 110.

As a result, the transfer plate 110 into which the battery cells B are inserted moves above the pressing cylinders 420, and the transfer plate 110 moves upward by means of the pressing cylinders 420 to allow tops of the battery cells B to be brought into contact with the top support plate 410, so that the coupled states of the battery cells B to the holder assembly 10 become firmly reinforced.

The holder assembly 10 created by the second holder assembling part 500 is coupled to tops of the battery cells B pressed against the first pressing part 400, and next, the battery cells B pass through the second pressing part 600 so that the coupled states of the battery cells B to the holder assembly 10 become firmly fixed to each other.

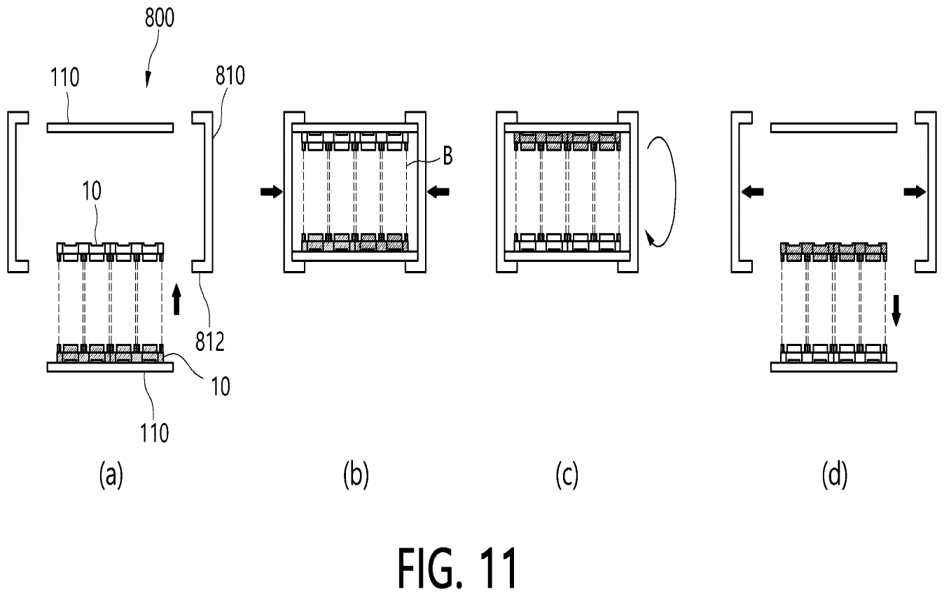

As shown in FIG. 11a showing operations of a semi-finished product reversing part of FIG. 1, the holder assemblies 10 are located on tops and undersides of the battery cells B passing through the second pressuring part 600. To allow the electrodes of the battery cells B to be connected to the holder assemblies 10, the conductive plate assembling parts 700 and 900 serve to couple conductive plates to the top side holder assembly 10 and the underside side holder assembly 10.

As shown in FIG. 1, the conductive plate assembling part 700 is a top conductive plate assembling part that is located on the side surface of the unidirectional transfer part 100 to couple the conductive plate to the holder assembly 10 fitted to tops of the battery cells B, and the conductive plate assembling part 900 is an underside conductive plate assembling part that is located on the side surface of the unidirectional transfer part 100 to couple the conductive plate to the holder assembly 10 fitted to the undersides of the battery cells B. In this case, the semi-finished product reversing part 800 is located between the top conductive plate assembling part 700 and the underside conductive plate assembling part 900 to allow the battery cells B to which the conductive plate is coupled by means of the top conductive plate assembling part 700 to be reversed.

The conductive plate assembling parts 700 and 900 are robots that cut nickel plates according to the arrangements of the battery cells B, move them to the holder assemblies 10 through their robot arms, and weld them to the holder assemblies 10. As shown in FIG. 11, if the battery cells B whose tops and undersides are coupled to the holder assemblies 10 are transferred together with the transfer plate 110 located above the battery cells B, the semi-finished product reversing part 800 moves the battery cells B upward to allow the holder assembly 10 coupled to tops of the battery cells B to be brought into contact with the transfer plate 110 located above the battery cells B, and as shown in FIG. 11b, plate holders 810 having locking projections 812 are located on sides of the transfer plate 110 move to fix the transfer plate 110 thereto, rotate the transfer plate 110 by 180° to allow it to be reversed.

The battery cells B whose top and underside holder assemblies 10 are reversed through the semi-finished product reversing part 800 move to the underside conductive plate assembling part 900 along the unidirectional transfer part 100, so that the conductive plates are coupled to the battery cells B.

Referring to FIG. 12 showing a flexible manufacturing device for a battery pack according to another embodiment of the present inventive concept, a flexible manufacturing device 1 for a battery pack includes a circulation transfer part 1100 for transferring a transfer plate 1110 along a circular trajectory, a holder assembling part 1200 disposed at a side of the trajectory of the circulation transfer part 1100 to create holder assemblies 10 and seat the holder assemblies 10 on the transfer plate 1110 or battery cells B, a cell supply part 1300 disposed at a side of the trajectory of the circulation transfer part 1100 to seat the battery cells B on the holder assemblies 10 transferred through the transfer plate 1110, and a conductive plate assembling part 1700 disposed at a side of the circulation transfer part 1100 to couple conductive plates to the holder assemblies 10 seated on the upper and lower portions of the battery cells B.

In the case of the flexible manufacturing device 1 for a battery pack according to the above-mentioned one embodiment of the present inventive concept, since the unidirectional transfer part 100 transfers the battery cells B and the holder assemblies 10 unidirectionally, the first holder assembling part 200, the second holder assembling part 500, the top conductive plate assembling part 700, the underside conductive assembling part 900, the first pressing part 400, and the second pressing part 600 are repeatedly located, but in the case of the flexible manufacturing device 1 for a battery pack according to another embodiment of the present inventive concept, the circulation transfer part 1100 is provided to circulatingly transfer the battery cells B and the holder assemblies 10, so that the components may not be repeatedly installed on the flexible manufacturing device 1.

As shown in FIG. 12, the circulation transfer part 1100 may be a robot arm, and according to embodiments of the present inventive concept, otherwise, a circular conveyor may be used as the circulation transfer part 1100.

The same components of the flexible manufacturing device 1 for a battery pack according to another embodiment of the present inventive concept as in the flexible manufacturing device 1 for a battery pack according to the embodiment of the present inventive concept will not be explained anymore, even if their reference numerals are different from one another, for the brevity of the description.

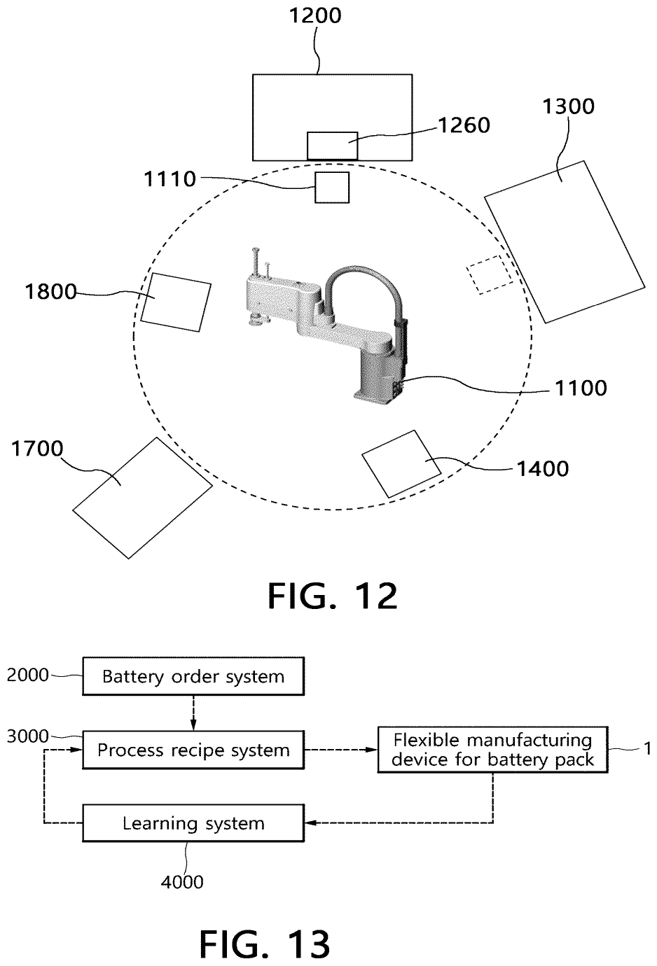

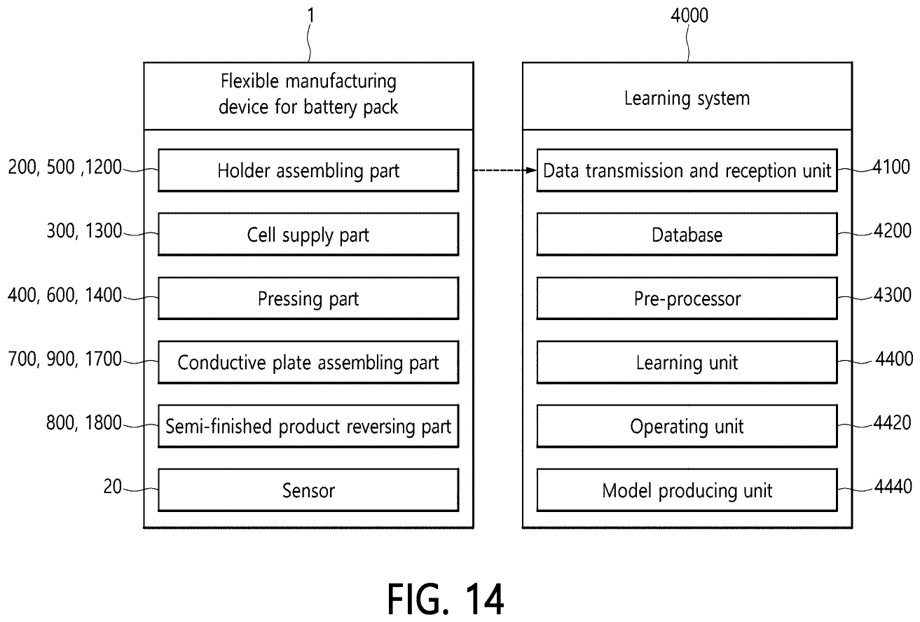

Referring to FIG. 13 that is a block diagram showing a flexible manufacturing system for a battery pack according to yet another embodiment of the present inventive concept and FIG. 14 that is a block diagram showing a flexible manufacturing device for a battery pack and a learning system of FIG. 13, an explanation of a flexible manufacturing system for a battery pack using the above-mentioned flexible manufacturing device 1 will be given in detail below.

As shown in FIG. 13, the flexible manufacturing system for a battery pack includes a battery order system 2000, a process recipe system 3000, and the flexible manufacturing device 1 for a battery pack.

The flexible manufacturing device 1 for a battery pack has been mentioned above, and therefore, explanations of the battery order system 2000 and the process recipe system 3000 will be given in detail.

The battery order system 2000 is a system that receives the requirements for the battery pack, such as an output voltage, charge and discharge capacities, and quantity of the battery pack, and the like from a customer who orders the battery pack and is connected to a wired or wireless communication network to allow the battery pack to be ordered in real time, irrespective of places.

The process recipe system 3000 analyzes the requirements received from the battery order system 2000 to produce a manufacturing process recipe for the battery pack. In detail, the process recipe system 3000 produces the manufacturing process recipe for the battery pack that includes the battery cells B, the arrangements of the holder assembly 10, the assembled speeds of the holder assembly 10, the feed speeds of the battery cells B, the transfer speeds, the lengths of conductive plates, the arrangement positions of the conductive plates, the welded positions of the conductive plates, the welding speeds, and the like, according to the requirements for the battery pack.

The manufacturing process recipe for the battery pack, which is produced from the process recipe system 3000, is transmitted to the flexible manufacturing device 1 for the battery pack so that the battery pack is manufactured according to the manufacturing process recipe for the battery pack.

The flexible manufacturing device 1 for the battery pack includes the holder assembling parts 200, 500, and 1200, the cell supply parts 300 and 1300, and the conductive plate assembling parts 700 and 900, as mentioned above, and therefore, they will not be explained anymore for the sake of brevity.

As shown in FIG. 13, the process recipe system 3000 may further include a learning system 4000 that receives operation record data of the flexible manufacturing device 1 for the battery pack to produce an optimized manufacturing process recipe model for the battery pack.

If the learning system 4000 is additionally provided, various sensors 20 are located on the holder assembling parts 200, 500, and 1200, the cell supply parts 300 and 1300, and the conductive plate assembling parts 700 and 900 of the flexible manufacturing device 1 for the battery pack to sense their operation record data and to transmit the sensed data to the learning system 4000.

In this case, the operation record data are transmitted from the sensors 20 to a data transmission and reception unit 4100 of the learning system 4100 and stored in a database 4200, and the operation record data stored in the database 4200 are rectified in a pre-processor 4300 and calculated as statistical data.

Based on the statistical data calculated through the pre-processor 4300, a learning unit 4400 calculates an amount of change in a process result according to the changes in process conditions and thus extracts the process conditions having influences on the amount of change in the process result.

Machine learning may be performed using all process conditions and the process results under the process conditions, but if various process conditions are provided, it is likely that the manufacturing process recipe model for the battery pack that is acquired through the machine learning may not be robust. Therefore, it is desirable that the machine learning is performed with the features of the process conditions having great influences on the amount of change in the process result if the process conditions are changed.

As shown in FIG. 14, the learning unit 4400 consists of an operating unit 4420 for analyzing the correlation between process factors and an amount of change in a process result through the statistical data to extract a high influence process condition on the amount of change in the process result and a model producing unit 4440 for making use of the extracted process condition to produce the manufacturing process recipe model for the battery pack.

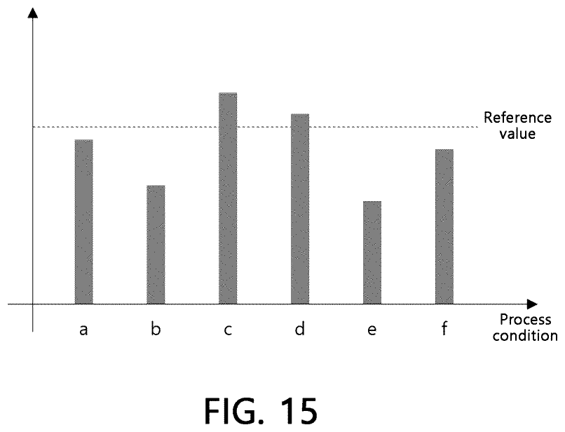

As shown in FIG. 15 that is a graph showing result values of changes in process conditions a, b, c, d, e, and f with respect to a reference value (for example, the reference value for indicating the number of products having poor quality), the operating unit 4420 determines the process conditions c and d having higher values than the reference value as the high influence process conditions, and the process conditions c and d are used as features of the machining learning in the model producing unit 4440. Further, the values (e.g., yields) appearing may be used as labels.

The manufacturing process recipe model for the battery pack, which is produced through the machine learning in the model producing unit 4440, is updated in the above-mentioned process recipe system 3000 and produced as the optimized manufacturing process recipe model for the battery pack if the battery pack is ordered by the customer.

The present inventive concept may be modified in various ways and may have several exemplary embodiments. Therefore, it should be understood that the present inventive concept is not limited by the embodiments as will be discussed later and has all modifications in the technical spirit and scope of the present inventive concept. That is, the present inventive concept may be freely modified by those of ordinary skill in the art through addition, change, and deletion of the components thereof within the scope of the inventive concept limited by the claims appended hereto, and the modifications may be within the scope of the claims.

1. A flexible manufacturing device for a battery pack, comprising:
a circulation transfer part for transferring a transfer plate along a circular trajectory;
a holder assembling part disposed at a side of the trajectory of the circulation transfer part to create holder assemblies and seat the holder assemblies on the transfer plate or battery cells;
a cell supply part disposed at a side of the trajectory of the circulation transfer part to seat the battery cells on the holder assemblies transferred through the transfer plate; and
a conductive plate assembling part disposed at a side of the circulation transfer part to couple conductive plates to the holder assemblies seated on the upper and lower portions of the battery cells.

2. The flexible manufacturing device according to claim 1, wherein the holder assembling part comprises a holder arranging plate and a holder member feeder and a pin member feeder spaced apart from each other around the holder arranging plate, and holder members fed from the holder member feeder and fixing pins fed from the pin member feeder move to the holder arranging plate through robot arms.

3. The flexible manufacturing device according to claim 2, wherein the holder arranging plate comprises a base plate and a plurality of protrusions protruding from top of the base plate, and each holder member consists of one cell insertion lead open on top and bottom thereof, grating walls bent from top corners of one cell insertion lead, and incised portions formed on one cell insertion lead under the grating walls, one side grating walls of the grating walls of one cell insertion lead being formed unitarily with the grating walls of the other cell insertion lead.

4. The flexible manufacturing device according to claim 1, wherein the robot arms comprise the robot arm that moves one holder member of the holder members fed from the holder member feeder to allow one protrusion of the holder arranging plate into the cell insertion lead of one holder member and moves the other holder member of the holder members fed from the holder member feeder to the side surface of one holder member to allow one protrusion of the holder arranging plate into the cell insertion lead of the holder member and the robot arm that moves the fixing pin fed from the pin member feeder to allow the fixing pin to be inserted between one holder member and the other holder member, so that the holder assembly is created.

5. The flexible manufacturing device according to claim 1, wherein the cell supply part comprises a cell moving slope along which the battery cells slide in one side direction, a cell aligner located on the other end of the cell moving slope to align the battery cells slidingly fed to the cell moving slope, a first cell grasping head for grasping the battery cells aligned on the cell aligner to move the battery cells to a cell seating plate located on the side surface of the unidirectional transfer part, and a second cell grasping head for grasping the battery cells that have moved to the cell seating plate to arrange the battery cells on the holder assembly created by the first holder assembling part and then seated on the transfer plate.

6. A flexible manufacturing system for a battery pack, which serves to arrange battery cells and create holder assemblies fitted to upper and lower portions of the battery cells according to requirements for the battery pack, the flexible manufacturing system comprising:
a battery order system for receiving the requirements for the battery pack from a customer;
a process recipe system for analyzing the requirements received from the battery order system to produce a manufacturing process recipe for the battery pack; and
a flexible manufacturing device for the battery pack which performs the manufacturing process recipe for the battery pack produced from the process recipe system,
wherein the requirements received from the battery order system comprise the quantity, size, output volage, and capacity of the battery pack, and the manufacturing process recipe for the battery pack comprises the arrangements of the holder assemblies.

7. The flexible manufacturing system according to claim 6, wherein the flexible manufacturing device for the battery pack comprises:
a holder assembling part for creating the holder assemblies according to the arrangements of the holder assemblies produced by the process recipe system;
a cell supply part for seating the battery cells onto the holder assemblies created in the holder assembling part according to the arrangements of the holder assemblies produced by the process recipe system; and
a conductive plate assembling part for cutting and coupling conductive plates to the holder assemblies according to the arrangements of the holder assemblies produced by the process recipe system.

8. The flexible manufacturing system according to claim 7, wherein the flexible manufacturing device for the battery pack comprises sensors located on the holder assembling part, the cell supply part, and the conductive plate assembling part to sense operation record data so that the data sensed through the sensors are transmitted to a learning system included in the process recipe system, and the learning system comprises:
a data transmission and reception unit for requesting and receiving the operation record data collected by the flexible manufacturing device;
a database for storing the operation record data received from the data transmission and reception unit;
a pre-processor for rectifying the operation record data stored in the database and calculating statistical data based on the rectified data; and
a learning unit for extracting process conditions having influences on the amount of change in a process result, based on the statistical data calculated through the pre-processor, to produce a manufacturing process recipe model for the battery pack.

9. The flexible manufacturing system according to claim 8, wherein the learning unit comprises an operating unit for analyzing the correlation between process factors and the amount of change in the process result through the statistical data to extract a high influence process condition on the amount of change in the process result and a model producing unit for making use of the extracted process condition to produce the manufacturing process recipe model for the battery pack.

10. The flexible manufacturing system according to claim 9, wherein the operating unit determines, if the amount of change in the process result that is made when a process condition is changed is over a reference value, the process condition as the high influence process condition.

11. The flexible manufacturing system according to claim 9, wherein the manufacturing process recipe model for the battery pack that is produced from the model producing unit is updated in the process recipe system.

12. The flexible manufacturing system according to claim 6, wherein the flexible manufacturing device for the battery pack comprises:
a circulation transfer part for transferring a transfer plate along a circular trajectory;
the holder assembling part disposed at a side of the trajectory of the circulation transfer part to create the holder assemblies and seat the holder assemblies on the transfer plate or the battery cells;
the cell supply part disposed at a side of the trajectory of the circulation transfer part to seat the battery cells on the holder assemblies transferred through the transfer plate; and
the conductive plate assembling part disposed at a side of the circulation transfer part to couple the conductive plates to the holder assemblies seated on the upper and lower portions of the battery cells.
